(19) United States
(12) Patent Application Publication
(10) Pub. No.: US 2020/0184273 A1
(43) Pub. Date: Jun. 11, 2020

(54) CONTINUOUS LEARNING IMAGE STREAM PROCESSING SYSTEM

(71) Applicant: Atollogy, Inc., Santa Clara, CA (US)

(72) Inventors: Jan Frederic Jannink, Menlo Park, CA (US); Zachary William Wellmer, Plymouth, MI (US)

(21) Appl. No.: 16/700,822

(22) Filed: Dec. 2, 2019

Related U.S. Application Data
(60) Provisional application No. 62/776,630, filed on Dec. 7, 2018.

(51) Int. Cl. G06K 9/62; G06N 20/00; G06K 9/00

(52) U.S. Cl. CPC G06K 9/6262; G06N 20/00; G06K 9/6256; G06K 9/00785; G06K 9/00771

(57) ABSTRACT

Systems and methods for continuous adaptive development of a model of a real world environment through data acquired by sensors disposed to observe that environment. The sensors provide a sensor data stream, e.g., audio/video data, to compute resources that are configured to archive the data stream, select portions of the data stream for analysis, annotate items of interest in the portions of the data stream, and analyze the items of interest according to an iteratively refining model. The model constitutes a digital summarized representation of an environment and subjects represented in the data stream, and is amenable to quality control, and thus to incremental improvement. The ever-updating model enables annotation and analysis of the data stream by the compute resources.

### RELATED APPLICATIONS

This is a NONPROVISIONAL of, claims priority to, and incorporates by reference U.S. Provisional Application No. 62/776,630, filed Dec. 7, 2018.

### FIELD OF THE INVENTION

The present invention relates to systems and methods for continuous adaptive development of a model of a real world environment through data acquired by sensors disposed to observe that environment.

### BACKGROUND

Operational environments such as factory floors, transportation hubs, and sorting and distributions facilities all involve complex interactions of people, products, and equipment. In efforts to enhance safety as well as traffic management and control, video surveillance of such areas have become more and more common. The video data captured by such systems is then subjected to automated analysis in order to detect instances of accidents or other abnormalities.

One difficulty associated with automated analysis of video data of the kind mentioned above is the ever-changing nature of the scene being monitored. Transportation hubs are typically characterized by fast moving automobiles, busses, and other vehicles. Airport gates are constantly experiencing arrivals and departures of aircraft as well as service vehicles and personnel. And factory facilities are often crowded with people and machines. In addition, lighting conditions for the scene may vary over the course of a few minutes, hours, or days and inconsistencies in the surveillance data due to shadows and the like may cause automated processes to register false positives and false negatives in their analyses.

Thus, while it is valuable to generate an increasingly accurate digital record of physical phenomena taking place in the world at large, for analysis and prediction, to date there have been no implementations of a complete system that captures a digital stream from external events, develops and iteratively refines an internal model of the external environment, and generates a digital summary of the events, which summary can be augmented as the internal model improves. The current state of the art does not easily incorporate new information captured with new devices into an existing model and does not have a general mechanism for continuously integrating and adapting to changing environments.

### SUMMARY OF THE INVENTION

Embodiments of the present invention provide a system that starts with as little as a single sensor's data and an imperfect or even nonexistent model of the sensor's environment. The system continuously adapts and learns from the acquired data from that sensor, and constantly grows by incorporating additional sensors, from which it then adapts and learns. The system is not limited in the number of sensors employed to capture aspects of a local environment, to whose changes the system is continuously adapting.

In one embodiment, a system for consistent improvement of a continuous analysis of an ever growing data stream includes one or more sources of image and or sensor data coupled communicatively to compute resources configured to archive the data stream, select portions of the stream for analysis, annotate items of interest in the portions and analyze the items of interest according to an iteratively refining model of the subjects of the data streams. The compute resources simultaneously develop and refine a digital summarized representation of an environment and subjects represented in the data stream. This summarized representation is amenable to quality control, and thus to incremental improvement, and enables improved annotation and analysis of the data streams by the compute resources when deployed to those compute resources as an updated subject model.

In some instances, the output of such a system may also be used to generate reports explaining the content of the data streams. Further, instances of such systems may enable persons familiar with the content of the subject reports to provide accuracy feedback on the source content, driving retraining and adaptation of the model. In some cases, a pretrained generic subject model may be contributed from an external source and/or an initial model may be contributed by manual annotation and training prior to initial deployment. Also, in such a system a system model that is trained online may be used simultaneously to analyze the data stream. By continuously generating new subject models through varying of model hyperparameters, training with those new parameters, and validating against existing models, the present invention enables a directed optimization search through the model parameter space, and continuous analysis improvement.

These and further embodiments of the invention are described in detail below.

### BRIEF DESCRIPTION OF THE DRAWINGS

The present invention is illustrated by way of example, and not limitation, in the figures of the accompanying drawings, in which:

FIG. 1 illustrates an example of a continuously learning data stream processing system that includes a feedback loop of image and sensor data stream capture by remote network-connected hardware devices, in accordance with embodiments of the present invention.

FIG. 2 illustrates an example of a training cycle for the continuously learning data stream processing system illustrated in FIG. 1.

FIG. 3 shows an example of the addition of scene configuration to new raw sensor data in accordance with embodiments of the present invention.

FIG. 4 shows an example of scene analysis and accuracy monitoring in accordance with embodiments of the present invention.

FIG. 5 shows an example of a training sequence for a machine learning model that leverages a previous iteration's accuracy measurements in accordance with embodiments of the present invention.

FIG. 6 shows an example of a sequence of auto encoder training and output that feeds a model adapted from an existing model in order to analyze a new data source in accordance with embodiments of the present invention.

### DESCRIPTION OF THE INVENTION

To better understand the present invention, it is helpful to first present an example before describing technical details. In this example, we use a bus stop as a real world environment to be modeled. The bus stop is observed by sensors of a bus stop monitoring system. The sensors provide data to processing units of the bus stop monitoring system, and the processing units operate on the data to provide output that assists in optimizing operational efficiency as well as safety of a transit system of which the bus stop is a component. Cameras mounted by a bus stop capture images of buses arriving and departing, passengers queuing and boarding, use of the bike rack or the wheelchair lift, and so on. Furthermore, the images signal the presence of a bus driver, the proper use of turn signals and other lights, confirm adherence to traffic lights, the location of any obstacles in the roadway, etc.

The images are a form of measurement of the bus stop, its users, and its characteristics. To accurately report these measurements from the bus stop, a digital representation of key elements of the scene (i.e., an instance of the bus stop at a particular time or time period) is generated using computer vision algorithms and machine learning models to extract data from the images and, optionally, other sensor streams. These algorithms and models encode features in the data streams both explicitly and implicitly, which features signify the presence, location, state and activity of people, doors, ramps, lights, etc., that are tracked for reporting purposes. A typical report may thus summarize a day's activity at the bus stop in terms of a timeline that shows bus arrivals and departures, variance(s) from schedule, safety issues, aggregate ridership information, etc.

One instance of a continuous monitoring system for a given bus stop will include a number of data capture devices; that number of devices being however many are sufficient to create a digital representation of bus stop activity, design algorithms and train models to extract the required features to report on events taking place. If additional bus stops are to be monitored, the same procedure of “instrumenting” that bus stop (and each successive one) with data capture devices may be employed. However, because the physical environment of each bus stop is different, it may be the case that little, if any, of the previous work is useful in completing a new deployment. Every difference in environment, such as sunrise/sunset times, seasonal weather, bus stop orientation, traffic, bus size and/or configuration, clothing, etc., will require new efforts to accommodate.

To initiate the continuous improvement process we make use of pretrained vision models and preexisting vision algorithms, which while not specific to the subjects likely to be encountered (and, therefore, needed to be recognized) at the bus stop, are sufficient to create a baseline from which to further develop the accuracy of the system. In some cases, a baseline may be established by training a model on existing data sets that match the subjects of the bus stop monitoring system. In the absence of preexisting data or models, a model may be created by using clustering algorithms to organize subjects by pixel similarity. With one of these baselines, it becomes possible to measure which clusters of subjects captured in actual monitoring situations are different enough from the existing model data and thus warrant adding to the training of the subsequent model. These improved subsequent models are tested in sandbox environments alongside the existing models and differences in performance are measured by checking where the existing and new models disagree. New models replace existing models when the performance of the new model surpasses the performance of the existing model.

To enable a learning system such as this to be fully adaptive it must not only respond to changes in the data arriving from the sensor streams, but also to updates in available algorithms and models. It must enable incorporation of new technology as it emerges. New technologies are also tested alongside existing models and undergo their own training cycle before they are introduced into the system. The rapid development of new machine learning methods is a case in point. We place new algorithms and models alongside the ones in place and evaluate their output against the results of the existing baseline. We can either take the combined results of this ensemble model or replace the incumbent models if they are inferior. In particular, this approach allows the incorporation of semi supervised and unsupervised methods that are trained directly by the output of the existing baseline

Each continuous improvement process in the system is established by a method of differences or comparison and perpetuated by measuring and validating against previous results. Each of these steps is automated and may be augmented with the addition of external data, models and algorithms, and manual verification and validation of the accuracy of the step. Iteratively incorporating new models and retraining existing models using the differences in inference between them, achieves both a speedup and a simplification of the overall system improvement. Because the continuous improvement is part of the machinery of the system it is also adaptive to environmental changes, unlike static algorithms and models.

A further benefit of incorporating the model retraining and improvement into the overall system is that it becomes possible to continuously generate new subject models by varying model hyper parameters. Taking multiple candidate subject models in this way, training them with those new parameters, and validating them against existing models, enables a directed optimization search through the model parameter space. At the end of each training cycle we preserve only the best of the candidates, if they supersede the existing models in accuracy.

When building a bus stop monitoring system from scratch the steps of physical design, algorithm design, dataset and network selection, dataset annotation, model training and accuracy validation generally proceed manually. Typically, this process is repeated for each new bus stop added to the system, in particular when the bus stops are not in the same transit system. Additionally, environmental changes such as seasonal differences in light exposure, introduction of new bus models, new traffic patterns introduced by road construction, etc., can force rework of datasets, models and algorithms. Deployment in new markets with double decker buses, left hand traffic and nighttime service will trigger more rework. Finally, the changes in the algorithms and models themselves imply a need to constantly evaluate incoming data against improved versions of existing models and new algorithms and models as they develop. What is needed is a system that learns continuously, starting from a minimal initial deployment of imperfect accuracy, and adapting as it grows to an increasingly accurate system that is not limited in size.

In embodiments of the invention, a continuously learning data stream processing system includes a feedback loop of image and sensor data stream capture by remote network-connected hardware devices, which is fed to servers that archive the streams, select a subset of the streams for analysis, annotate items of interest in the stream subsets, and analyze said items according to a refinable model of the subjects of the streams, returning a digital summarized representation amenable to quality control and comparison with the original data streams, which digital summarized representation enables iterative improvement of the analysis functions, iterative refinement of the subject models as well as their deployment through a systemwide release mechanism that updates all of the system devices.

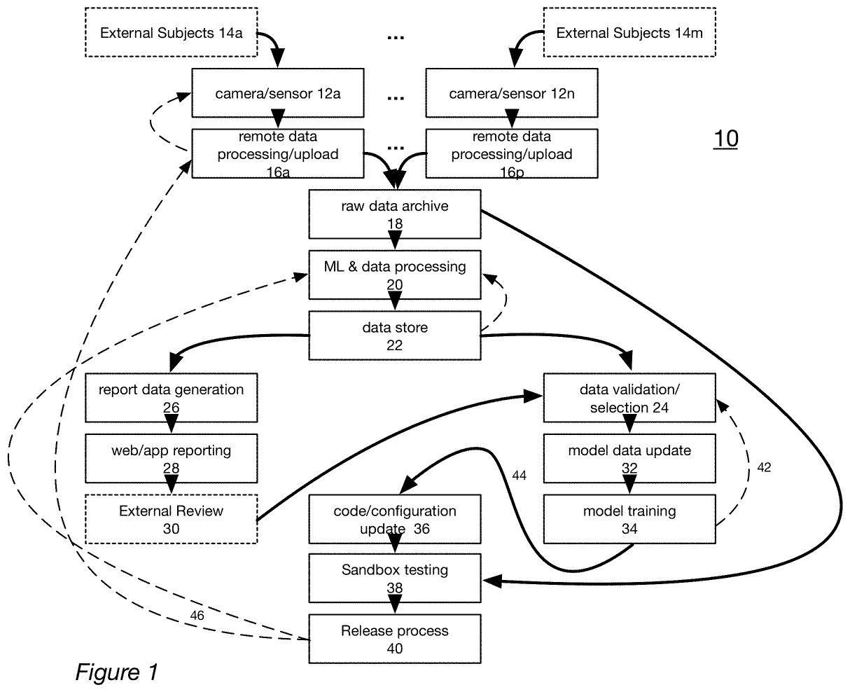

The above is best understood with reference to the accompanying figures. In FIG. 1, an example of the above-described feedback loop 10 is depicted. Within this loop, a data stream that originates with cameras and/or other sensors 12a-12n that observe/monitor external subjects 14a-14m, passes through and is acted upon by the system, causing updates to models of the sensor environment, stream analysis functions, hardware devices, and software configurations of those devices through which the data streams flows. In FIG. 1, the normal top to bottom flow of data, represented by solid arrows, is supplemented by feedback data, configuration, model, and code flow, which proceeds upwards (i.e., is back-propagated within the system) as represented by dashed lines.

The data stream that is passed within feedback loop 10 is an image and sensor data stream from the cameras and/or other sensors 12a-12n. It may for example, be characterized by continuous capture and transmission of raw digital signals (e.g., images, sound, temperatures, pressures, etc.) corresponding to camera or sensor measurement(s) of an external environment. In the example illustrated in FIG. 1, this is illustrated as the capture, by camera(s) and/or sensor(s) 12a-12n, of external subjects 14a-14m and the transmission of the captured signals to the monitoring system.

The camera(s) and/or sensor(s) 12a-12n are examples of remote, network-connected hardware. In addition to cameras and other sensors, such hardware may include compute and/or beacon hardware placed in the monitored physical environment, either networked themselves via wired or wireless communication means, or possibly directly connected to a local compute device that can generate signals and transmit measurements through a network to servers for archival and analysis. As illustrated in FIG. 1, the data from the remote, network-connected hardware resources is processed/uploaded at or through one or more resources 16a-16p and stored in a raw data archive 18.

The persisted data stream(s) from the archive 18 are then analyzed by networked compute elements (e.g., servers) based on a model of the environment in which the streams are generated. Subsets of the streams are selected, and the models refined based on the subsets. For example, as shown in the example of FIG. 1, the raw data from archive 18 is operated upon by machine learning (ML) and data processing elements 20, according to a model of the environment being observed by the cameras/sensors, and then stored in a data store 22. The model may be regarded as a system specification which combines versioned configuration data, analysis algorithms, and machine learning that enable the servers to extract a digital summary of items of interest present in the captured data streams of the instrumented environment. The versioning represents a reproducible representation of the system at a given time. The subset selection process is implemented by a combination of algorithms that choose, out of the entire data stream, the portions of the data stream that enable refinement of the model in respect of the items of interest. In one embodiment, these algorithms implement one or more of: first, a balanced sampling of all of the related sensor streams, balanced by time, position, amplitude, device, class of item of interest, etc.; second, a sampling by distribution of high dimensional feature distance, when the signal is content indexed; and third a sampling by distribution of weights in the machine learning model representation of the signal. Optionally, human-assisted sampling of the streams based on expert observation of the stream content may also be employed. In FIG. 1, this process is represented by a data validation/selection operation 24, supplemented by report data generation 26, web/app reporting 28, and (optional) external review 30.

Based on the data validation and selection, model data is updated 32. As mentioned above, this involves annotation of items of interest in the stream subsets. To perform this operation, a combination of algorithms that localize items of interest temporally and spatially in the data streams is used. These algorithms first, measure and mark amplitudes of change in the signal streams; and second, measure and mark rhythmic/patterned changes in the data streams. Optionally, human-assisted annotation of position and time of classes of items of interest in the data streams may be use as well. The updated model data may then be employed for model training 34. The received data streams are run through analysis algorithms that return a digital summary of the streams' items of interest in the form of the sets of above-mentioned annotations. The model of the instrumented environment is thus a refinable model in that it is amenable to iterative updates that improve its accuracy. For example, configuration changes that localize more precisely in an image stream the occurrence of items of interest, or a machine learning model whose training can be resumed with the adjunction of new training data. In FIG. 1, this iterative process is represented by the loop between the data validation/selection, model data update and model training processes.

The digital summarized representation of the sensor environment is the combination of the data streams captured by the cameras, sensors, and beacons in the environment, together with the annotations that are produced by the analysis algorithms in the system into a unified model that represents the subjects of interest. In FIG. 1, this is represented at the transition 44 from model training to code/configuration update 36. To allow for quality control, a combination of algorithms that provide a decision process as to the accuracy of annotations produced by the system may be employed. For example, algorithms that provide first, measurements of the drift and variation of the change patterns identified by the annotation process, second, comparison of differences of model output between model versions, and, optionally third, human-assisted validation of annotation output generated by the system compared with the data streams or the physical sensor environment. In FIG. 1, this is identified as sandbox testing 38.

As noted, these digital, summarized representations enable iterative improvement of the analysis functions and iterative refinement of the subject models as well as their deployment through a systemwide release mechanism that updates all of the system devices. The initial version of the system model enables data collection to begin. This data collection provides an initial input to the feedback loop in which the first representations of the physical sensor environment are stored and deployed. Subsequently, the feedback enables improved versions of analysis algorithms and machine learning model hyperparameters to be selected for the system model. The refinement process is called the training cycle and a separate training pipeline performs all of the functions necessary to complete this function.

By release deployment, we refer to a system service that updates the system components with configuration, software, and machine learning models to continue the iterative processing of incoming data streams. In FIG. 1, this is represented by release process 40 and feedback 46 of code/configuration and models to the monitoring system.

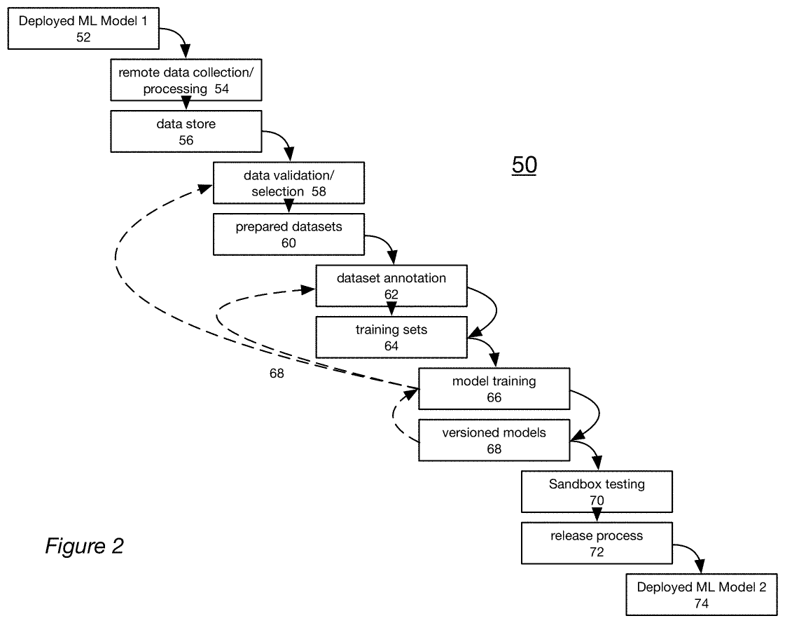

Turning now to FIG. 2, an example of a training cycle 50 is shown. This repeated sequence of operations includes dataset selection and preprocessing, training model generation, validation, and tuning. The linearized path of subject sensor data from initial capture through to the generation of a trained model that is used to identify subsequent captured data represents a training pipeline. In FIG. 2, the data flow from top left to bottom right is this pipeline. Using a currently deployed ML model 52, the pipeline begins with remote data collection 54. A combination of compute, camera, sensor, and beacon hardware is used to capture and initially process the stream of data from the external environment. This processed raw data is stored in a data store 56.

Next comes training data selection 58. As indicated above, this is performed using a combination of algorithmic and, optionally, human, selections of data from the pipeline for use in model training. The resulting datasets 60 are then made available for later pipeline stages.

The data validation/selection procedures (steps 24 in FIGS. 1 and 56 in FIG. 2) in the image stream processing system proceeds in multiple ways. In the simplest, the image classification or recognition results from a random selection of images are compared against other recognition methods. These methods include but are not restricted to machine vision algorithms, prior versions of the model, models trained on different samplings of the same data set, or manual classification. Rather than random selection, the validation process will also bias the selection toward images similar to those where the confidence score of the analysis is low. The process may also bias toward images where the other recognition methods above disagree with the model. Also, the sample selection may bias toward images similar to those categorized as incorrect by earlier iterations of the validation process. Feeding the output of the validation process back to the model training process is the essence of an active learning function.

Given an image stream processed in the machine vision pipeline there are three natural triggers for an active or adaptive learning process to initiate. Whenever a model is processing an existing stream, a validation step, manual or automated, on the output will catch errors, both false positives and false negatives for the objects of interest to the model. When the error rate exceeds a defined bound, a simple active learning process will be invoked that presents a subset images from the stream that are similar to the discovered errors in the validation process. Similarity is defined in one implementation as a linear combination of the metric of the model's domain and other simple metrics. Cosine distance between the source images is one such a simple metric. In this way, when there are initially no appropriate deep learning models defined on the stream a clustered subset of low similarity images can be used for the initial active learning process. Additionally, when there exists a suitable pretrained model for the new image stream it may serve as the image selection basis for an active learning process to support transfer learning on that model. Lastly, when a new image source is added to the running system a subset of clustered positive and negative samples in the existing model metric is generated to serve as input for the active learning process. The label data generated from the process may then be used as supplemental training data for an updated version of the model.

Returning to FIG. 2, at 62, dataset annotation occurs. Thereafter, training sets 64 are created to be used in the creation of trained models to recognize the subjects of data capture. These training sets are used in model training 66 to produce different versions of the model of the environment 68. The repeated process of training and validating models, and the loops 68 of further dataset generation, and annotation needed to produce an updated model tend to make each successively trained model superior to the previous one.

The performance of deep learning systems is deeply influenced by what we define as noise in the training sets as well as the image streams processed through a deployed model. Image noise can be understood as artifacts in the image that transform the objects of interest into less than canonical examples for recognition purposes. A non-exhaustive list of these are environmental effects such as glare, reflections, and shadows, background variability due to trees, sky, and irrelevant activity, foreground variability due to rain, snow, dust, camera lens obstructions, as well as item of interest overlaps and obstructions, particularly when multiple items occur in the same image. Both false positives and false negatives occur due to image noise. Automated noise mitigation processes reduce the occurrence of both iteratively. Environmental effects are among the harder ones to remedy algorithmically, without physically transforming the camera environment. This is because these effects most frequently result in false negatives of recognition in the image stream. Combining multiple images through an averaging filter with shorter or longer exposures is effective in these cases. The image stream can be so reconfigured when a characteristic signature of glare or shadow occurs in the images. Foreground variability is also improved through recognizing characteristic signatures of noise and applying an averaging filter, but without modifying exposure length.

Background variability and peripheral image noise is a frequent source of false positives in the image stream. This variability may be averaged out when items of interest in the foreground are more static or is made possible by increasing the frame rate of the camera. These patterns and regions of variability are recognizable by a characteristic signature. Peripheral image noise is filterable by cropping images submitted to the system so they focus on the region of interest for detection. Cameras with remote control capabilities, such as pan tilt zoom cameras are reconfigured to exclude persistent peripheral noise.

When images having an absence of items of interest persistently cause false positives in the image pipeline it is possible to create an additional ground or background image class to exclude those images from the classes of interest. It is important to apply the simpler noise mitigation processes before retraining the network with a new class. Such added classes will be camera specific, unless cameras are very consistently placed and configured. As the training sets grow over time the sample space of items of interest becomes much more complete and the occurrence of false positives from the background decreases, and the need to continue training for background artifacts drops. When item overlap and obstruction become frequent in the image stream, it is possible to expand the model training set to include partial items of interest. Accuracy of these extended models is closely tied to the availability of a largest number of partial items, extending the training process. The severity of these problems is also greater when the training sets are smaller and have less variation. Noise mitigation is one of the key aspects of scaling the system from its highly specific initial configuration to a fully realized accurate and generic model.

In FIG. 2, the sandbox testing 70 of the output model prior to its release and replacement of existing models allows for validation. This testing may compare the output of the new model against a previously validated “golden data set” output of the existing models. Assuming the new model is deemed acceptable in that it accurately reflects the instrumented environment (perhaps within predetermined tolerances), the updated model is released 72, and the now-deployed new ML model 74 assumes the place of the original model 52 for further data collection and analysis. As should be evident, the end of one training cycle is also the start of the next one.

As should now be apparent from the above discussion, the present invention goes beyond conventional image processing using machine learning. Efforts in that field have, prior to the present invention, focused on analyzing a given subject in an image, e.g., to identify the subject with a given confidence level. The present invention is concerned with evolving such a system to identify or label incrementally more subjects in an image stream over time, and in additional image streams that progressively supplement the original image stream. It applies more generally to learning systems that must collect incrementally larger amounts of data, identify progressively more types of signals within the data, and incrementally improve the correctness and quality of the identified signals returned.

Such a system begins with an autonomous data capture device; a sensor which can capture, record, and transmit a physical signal such as an image, sound, vibration, pressure, temperature, chemical concentration, or other samples. Over time, a video or audio recording or stream of image or other signal samples represent a sequence of measures. In many instances, the data capture device will be one or more image capture devices which collect image stills at regular intervals or continuous video. Captured images are digitized and forwarded over a network to a service which collects and archives these image streams along with any accompanying metadata. Processing of the images may happen in a computer associated with each capture device independently of other images, or jointly with other devices' images in computers associated with the image archival service. In either case, an extensible profile will exist for each image stream describing subjects of interest in the scene as well as any processing steps that the stream undergoes. The output of the image processing for each image is added to the metadata or model extracted from the image stream.

As was discussed above with reference to FIG. 1, the data capture device generates a data stream which is transmitted by network to a remote computing system that records the stream and generates a model of the content of the stream composed of a configuration that identifies the areas of interest in the scene or subjects, and a report which consists of a series of labels and positions in time and space of the items that appear in the subject areas of the sensor. Initially the model is empty, and the computer system simply archives the data stream. Model building consists of a feedback loop on the data stream that consists of automatically derived or manually computed functions applied to the stream, and iteratively refined. To refine such a process, it is necessary to define an update threshold and quality benchmark that is specifically geared towards it. The quality benchmark may be iteratively applied to modified versions of the process handling the data stream, and when the threshold is met a system update trigger causes deployment of the adjusted process throughout the system. The following are examples of tunable processes—the first three mandatory for a complete continuous learning system—that can be applied against the system's data streams.

Generation of a configuration for the scene (automatic or manual).
a. Automatic: representation of change in the scene.
b. Manual: bounding regions for areas of interest.

As an example, representation of change can be a heat map that measures pixel variation in the scene over time, or a boundary between foreground (dynamic) and background (static) pixels. Likewise, bounding regions can be coordinate sets stored with other metadata for the scene. An update threshold can be a stability measure on the pixel variation map.

Analysis of the activity of the subjects in the scene (automatic or manual).
a. Automatic: spatial and temporal pattern elaboration from the areas of interest.
b. Manual: routines labeling positions and times of items in areas of interest.

Patterns can be as simple as frequently occurring pixel patches. An update threshold may consist of the identification of a recurring pixel patch at a minimal frequency. Routines are code that identify, and label items observed in the areas of interest. A quality benchmark may consist of a manual verification of a random sampling of the labeling produced by the routines.

Monitoring of model accuracy (automatic or manual).
a. Automatic: sample and validate model output against output from a differently derived algorithm.
b. Manual: quality control of model output against source data.

Different algorithms, or different parametrization of an algorithm can serve as validation of the output of a main algorithm. A visual inspection of raw source data compared to the output of the routines serves as an accuracy measurement. Likewise, disagreement between different implementations of the same accuracy monitoring processes can serve as an indicator of required updates.

Optionally: Tuning/training of model generation system (automatic or manual).
a. Automatic: compare accuracy of system augmented with new data, and with parameter changes against earlier baseline.
b. Manual: update labelling routines and compare against previous benchmark.

Data and parameter tuning of a model and measuring against an earlier baseline result allows models to continuously evolve over time. The update trigger for a model can be the improvement of a model variant as compared to the running model by some predefined rate.

Optionally: Modeling new streams against existing models (automatic or manual).
a. Automatic: cluster new stream data patterns and label from existing model on another stream.
b. Manual: adjust labelling routines for new scene environment.

Before any analysis of new data streams occur, it is possible to organize the stream into related groups based solely on the content and use this organization to see if previously existing processes can handle the new groups. A quality benchmark can be the successful clustering of a set percentage of subjects continuously present in the scene.

All of the above processes are to be applied in sequence to the data streams as they are added to the stream processing system. Each process type enumerated above depends on model output from the previous ones in order to produce model output itself (producing none if the previous processes have not produced output themselves). This is why the initial function of the system simply archives the data stream. After a first system update it becomes possible to start processing the image stream for labels identifying subjects and their state in the data stream, Once these labels start appearing in the model output it becomes possible to measure their accuracy and trigger a subsequent set of system updates.

Each of the processes may also iteratively perform a reduced form of processing or training on a previously acquired set of output data. If a quality threshold is met on the training cycle, then it is possible to trigger a production system update. These tighter training cycles occur separately, but in parallel with the larger full production data collection and processing cycle.

The systematic and uniform implementation of quality benchmarks and update thresholds enables a systematic bootstrapping of feature identification of subjects in the scene embodied in the dataset, enabling a continuous learning and refinement of the model of the scene extracted by the processing system.

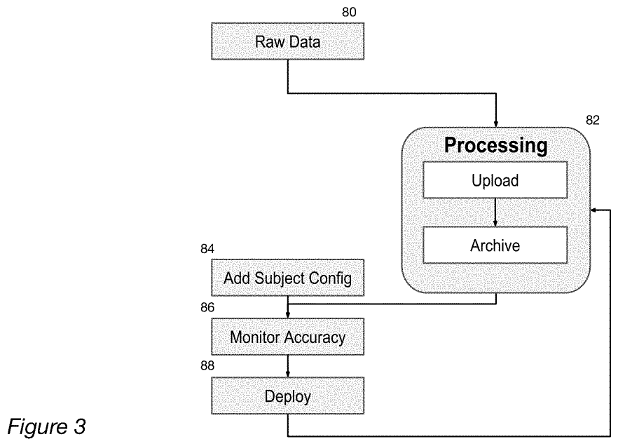

FIG. 3 shows an example of the addition of scene configuration to new raw sensor data which until then was simply archived. As before, the provision of a feedback loop is integral to the process. Raw data 80 undergoes processing 82 according to an existing model before being stored. To the stored datasets are added the scene configurations 84, and new models resulting therefrom are validated for accuracy 86 and, if deemed acceptable, deployed 88, where they become the models by which new raw data captures are processed.

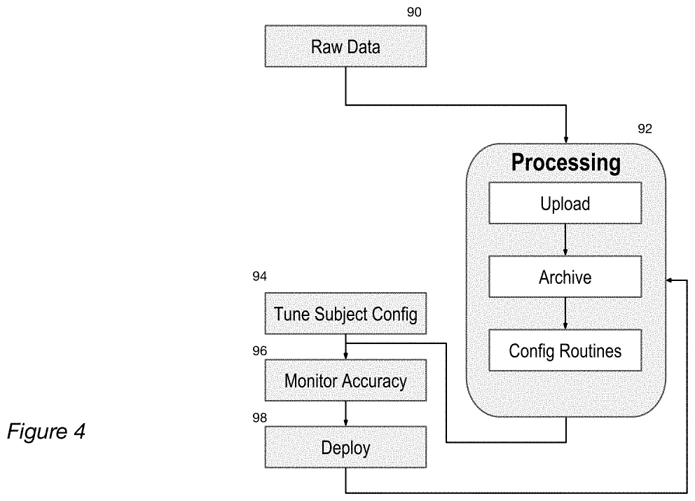

FIG. 4 shows an example of the scene analysis and accuracy monitoring. Raw data 90 undergoes processing 92 according to an existing model before being stored. Configuration routines are run against the stored data and to the resulting datasets are added tuned subject configurations 94. New models resulting therefrom are validated for accuracy 96 and, if deemed acceptable, deployed 98, where they become the models by which new raw data captures are processed.

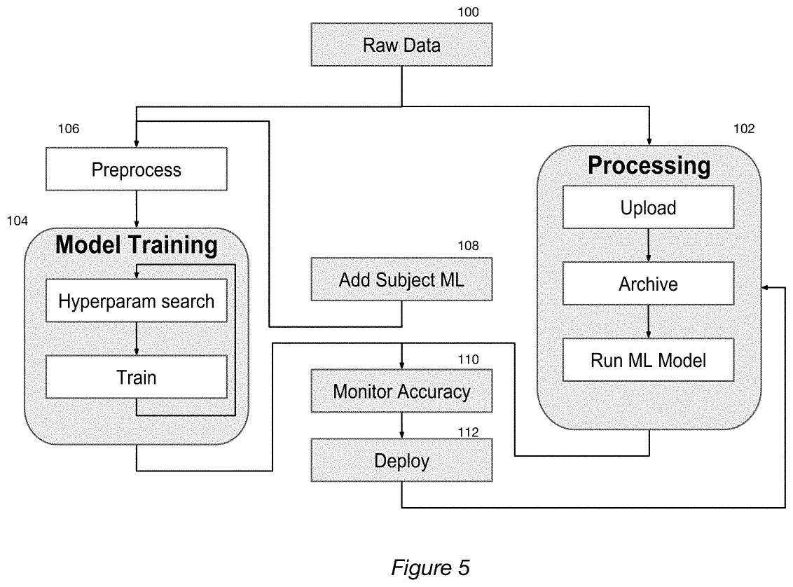

FIG. 5 shows an example of a training sequence for a machine learning model that leverages a previous iteration's accuracy measurements. Raw data 100 undergoes processing 102 according to an existing model before being stored. ML models are applied to the stored data and to the results are added those from newly trained models 104. The newly trained models are the result of preprocessing of the captured data 106 according to existing models 108 and modified parameters. The results are validated for accuracy 110 and, if deemed acceptable, deployed 112, where they become the models by which new raw data captures are processed.

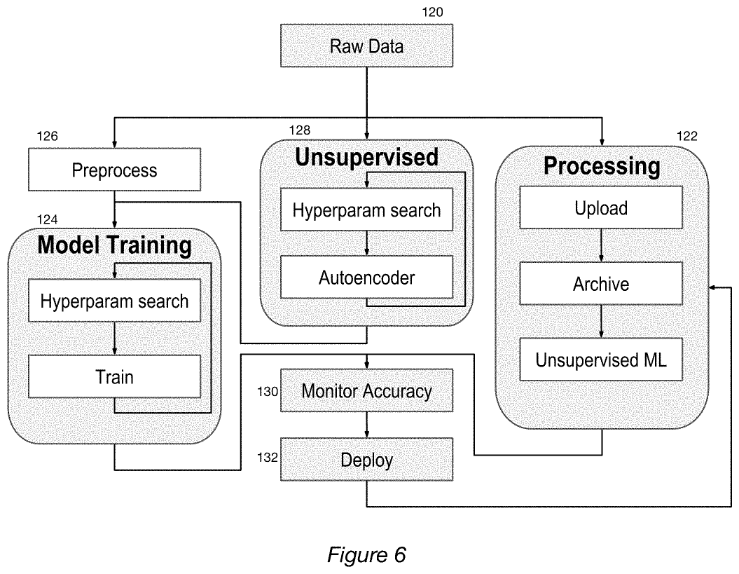

FIG. 6 shows an example of a sequence of auto encoder training and output that feeds a model adapted from an existing model in order to analyze a new data source. Raw data 120 undergoes processing 122 model before being stored. Unsupervised ML models are applied to the stored data and to the results are added those from newly trained models 124. The newly trained models are the result of preprocessing of the captured data 126 according to existing models 128 which themselves are continually updated. The results are validated for accuracy 130 and, if deemed acceptable, deployed 132, where they become the models by which new raw data captures are processed.

Thus, systems configured in accordance with embodiments of the invention include remote autonomous sensors that supply data streams to a computer system for processing, and optional computing devices associated with the remote sensors to preprocess the stream. The stream processing computing devices include:
a. A raw data archive to receive the data stream from the sensors.
b. A scene/subject/configuration store to manage collection and changes to the sensor scene.
c. A scene processor to apply functions against the streams.
d. An accuracy monitor to sample and validate the output against the data stream.
e. A training module to parametrize and train models to label the scene subjects.
f. A training set store to manage the datasets that generate models that operate against the streams.
g. A model store to manage the models generated by the training module.
h. A clustering system that may be used to start generating labels for a new data source from those identified from other sources.
i. A configuration manager to deploy software to the autonomous sensors and computer system.

The continuously updating output of the system includes:
a. Raw sensor data.
b. A configuration of the features/subjects found in the sensor data.
c. A report containing:
   i. Labels.
   ii. Times/intervals, locations/regions each label occurs.
d. Models/Routines for generating data configuration and report. Just as the system may incorporate manual or automatic processes, the system may also incorporate data, training sets and models from external sources to improve the initial speed and accuracy of the stream processing.

Thus, systems and methods for continuous adaptive development of a model of a real world environment through data acquired by sensors disposed to observe that environment have been described. The sensors sample their environment at regular intervals. The samples, taken as a sequence, form a data stream, which data stream is communicated to computing devices that will process or forward the collected data. The remote sensed data may be aggregated by intermediate computing devices, which may precompute some differential analyses before sending the digitized samples and analyses to a, possibly distributed, data store in which further differential analyses of the data can be computed. These streams of collected data and differential analyses are finally collected in a distributed data store such a way that the extracted features of their subjects may be summarized and presented in ad hoc ways. The data store and its contents as such represent a digitization and a summary of the physical environment measured and sensed by the system of sensors, computing, and storage devices described above.

The data passing through and observed by the system is, generally, a stream of information with well-defined temporal and positional characteristics. It may comprise a time series of images captured by a single camera, augmented over time by image time series coming from multiple cameras in the nearby vicinity and later expanded to multiple sites. These image series represent millions of pixel sequences, each with temporal and positional properties that relate them. Such streams are amenable to processing by functions that measure differences between neighbors both in time in space. Such functions can be difference functions, sampling functions, aggregating functions, clustering functions, spectral functions and transforms which extract signatures of change from the streams in time and space. Any function over the streams which calculate differences in the streams, such as a brightness function, may serve to extract patterns from the data. The systematic application of such functions to the streams constitute a differential analysis, and multiple such analyses can be computed in parallel on the same data or on the outputs of the prior analysis. The outputs of the differential analysis are in this regard simply treated as additional data streams correlated to their source input streams.

Analyses applied to the data streams serve to illuminate, bound, tag, compare, refine patterns of change sensed in the physical world. By systematically applying them to increasing numbers of data streams it becomes possible to distinguish overall patterns of data that can be thought of as a background pattern, and then with reapplication the patterns which differ from the overall pattern. In systems configured in accordance with the present invention, growing numbers of data streams captured by real world sensors are operated upon using computational approaches to recognize patterns, foregrounds and backgrounds. From those streams, foreground patterns are optimized into growing numbers of increasingly refined object collections. The continuous refinement of the analysis of the data stream constitutes a learning process on the stream, which then extends to other streams as they are added to the system.

In the foregoing description, the operations referred to are machine operations. Useful machines for performing the operations of the present invention include digital computers (e.g., the aforementioned “servers” and “networked compute elements”), or other similar devices. In all cases, the reader is advised to keep in mind the distinction between the method operations of operating a computer and the method of computation itself. The present invention relates to method steps—that is, the algorithm(s) executed to produce the desired results—for operating a computer, coupled to a series of networks, and processing electrical or other physical signals to generate other desired physical signals. The apparatus for performing these operations may be specially constructed for the required purposes or it may comprise specially-programmed computer(s), where the programming is stored in the computer's(s') memory(ies) or other storage elements. For example, such a computer program may be stored in a computer readable storage medium, such as, but not limited to, any type of disk including floppy disks, optical disks, compact disk read only memories (CD-ROMs), and magnetic-optical disks, read-only memories (ROMs), flash drives, random access memories (RAMs), erasable programmable read only memories (EPROMs), electrically erasable programmable read only memories (EEPROMs), flash memories, other forms of magnetic or optical storage media, or any type of media suitable for storing electronic instructions, and each accessible to a computer processor, e.g., by way of a system bus or other communication means.

Generally, computer systems upon which embodiments of the invention may be implemented include a bus or other communication mechanism for communicating information, and one or more processors coupled with the bus for processing information. Also includes are a main memory, such as a random access memory (RAM) or other dynamic storage device, for storing information and instructions to be executed by processor and for storing temporary variables or other intermediate information during execution of such instructions, and a read only memory (ROM) or other static storage device for storing static information and instructions for the processor. Other storage devices, such as a magnetic, optical disk or solid state disk may also be provided and coupled for storing information and instructions. All of the various storage devices are coupled to the bus for communication with the processor(s). Computer system upon which embodiments of the invention may be implemented may also include elements such as a display for displaying information to a user, one or more input devices, for example, alphanumeric keyboards for communicating information and command selections to the processor(s), cursor control device for communicating direction information and command selections to the processor(s) and for controlling cursor movement on the display, etc. And, the computer system also may includes a communication interface that provides a two-way data communication over one or more networks. According to one embodiment of the invention, the algorithms provided herein execute on a computer system by way of the processor(s) executing sequences of instructions contained in main memory. Such instructions may be read into main memory from another computer-readable medium, such as a ROM or other storage device. Execution of the sequences of instructions contained in the main memory causes the processor(s) to perform the process steps described above.

What is claimed is:

1. A system for consistent improvement of a continuous analysis of an ever growing data stream, comprising one or more sources of a sensor data stream coupled communicatively to compute resources configured to archive the data stream, select portions of the data stream for analysis, annotate items of interest in the portions of the data stream, and analyze said items of interest according to an iteratively refining model developed by said compute resources, said model constituting a digital summarized representation of an environment and subjects represented in the data stream, said summarized representation being amenable to quality control, and thus to incremental improvement, and which summarized representation enables annotation and analysis of the data streams by the compute resources when deployed to those compute resources as an updated subject model.

2. The system as in claim 1, wherein the compute resources are further configured to generate output reports explaining content of the data streams.

3. The system as in claim 1, wherein a first instance of the model used by the compute resources comprises a pretrained generic subject model contributed from an external source.

4. The system as in claim 1, wherein first instance of the model used by the compute resources comprises an initial model contributed by manual annotation and training prior to initial deployment of the model.

5. The system as in claim 1, wherein an instance of the model used by the compute resources comprises a system model that is trained online simultaneously to being used to analyze the data stream.

6. The system as in claim 1, wherein the model used by the compute resources is iteratively refined by continuously generating new instances of candidate models by varying model hyperparameters, training with the new parameters, and validating against existing instances of the model, enabling a directed optimization search through the model parameter space, and continuous analysis improvement.

7. A method, comprising:
receiving, at a server and from a plurality of sensors that monitor external subjects, a sensor data stream;
storing, by the server, the sensor data stream in a raw data archive;
analyzing, by one or more networked compute elements, the sensor data steam stored in the raw data archive by operating on the sensor data stream with machine learning and data processing elements according to an initial model of an environment in which the sensor data stream is generated to extract and store a digital summary of items of interest present in the sensor data stream; and
based on the analysis, updating the initial model of the environment to a versioned model of the environment, and repeating the receiving, storing, and analyzing of future sensor data streams using the versioned model of the environment.

8. The method of claim 7, wherein the sensor data stream is characterized by digital signals representing measurements of an environment within which the external subjects exist.

9. The method of claim 8, wherein the sensor data stream includes some or all of images, sound, temperatures, and pressures.

10. The method of claim 7, wherein the analyzing includes a data validation/selection operation and report generation.

11. The method of claim 10, wherein the data validation/selection operation includes one or more of: a balanced sampling of related sensor data streams, balanced by time, position, amplitude, device, and/or class of item of interest; a sampling by distribution of high dimensional feature distance when the signal is content indexed; and a sampling by distribution of weights in the machine learning model representation of the signal.

12. The method of claim 7, wherein updating the initial model of the environment to a versioned model of the environment includes annotating items of interest in subsets of the sensor data subsets.

13. The method of claim 12, wherein annotating items of interest comprises localizing the items of interest temporally and spatially in the sensor data stream.

14. The method of claim 13, wherein annotating items of interest further comprises measuring and marking amplitudes of change in signals that make up the sensor data stream and measuring and marking patterned changes in the sensor data stream.

15. The method of claim 14, wherein prior to repeating the receiving, storing, and analyzing of future sensor data streams using the versioned model of the environment, employing the versioned model of the environment for model training.

16. A method, comprising:
using an initial version of a model of an environment under observation by a plurality of sensors, collecting data via the sensors to provide an initial input to a server configured to analyze the input, said initial input presented to the server as a data stream of signals captured by the sensors in the environment;
using feedback, repetitively analyzing the data stream of signals using iteratively improved versions of analysis algorithms and machine learning model hyperparameters for a model of the environment, wherein for each iteration of the analysis of the data stream, generating updated instances of the model of the environment, testing the updated instances of the model of the environment, and selecting and releasing one of the updated instances of the model of the environment in place of an immediately preceding model of the environment used to analyze the data stream in a next iteration of the analysis of the data stream.
